(19) United States
(12) Patent Application Publication
(10) Pub. No.: US 2003/0105808 A1
(43) Pub. Date: Jun. 5, 2003

(54) Internet broadcasting apparatus and method

(76) Inventor: Hong Kil Lee, Suwon (KR)

Correspondence Address: David Tichane, 979 Pinto Palm Terrace, #24, Sunnyvale, CA, 94087, US

(21) Appl. No.: 10/011,837

(22) Filed: Dec. 5, 2001

(51) Int. Cl. G06F 15/16

(52) U.S. Cl. 709/203; 709/246

(57) ABSTRACT

An Internet broadcasting apparatus and method in which a server stores news picked up by subscribers and transferred over the Internet, along with information about the news assigned with a nation code and a news subject code, after sorting the transferred news according to nations, and subsequently supplies, in response to a news subject code entered by a client wanting to view news and corresponding to particular news in a particular nation, associated news to a client's terminal. The apparatus includes terminals each operating in a news transfer mode or a broadcast view mode. The server outputs, based on nation and news subject codes transferred from a terminal transferring news, sorting control information for sorting the news transferred from the terminal, and translation control information for designating a language, into which the news is to be translated. The apparatus also includes a memory unit for storing the news, an automatic translating system for automatically translating news data outputted from the memory unit into the language designated based on the translation control information, and a mixer for mixing the translated news data with the news data from the memory unit, and transferring the mixed data via the Internet to desired terminals.

### BACKGROUND OF THE INVENTION

1. Field of the Invention

The present invention relates to an Internet broadcasting apparatus and method, and more particularly to an Internet broadcasting apparatus and method in which a server stores news picked up by subscribers and transferred over the Internet, along with information about the news assigned with specific codes (including a nation code and a code representing the kind of news), after sorting the transferred news according to nations, and subsequently supplies, in response to a subject code entered by a client wanting to view news and corresponding to a particular news subject such as political news or sports news in a particular nation, associated news to a client's terminal.

2. Description of the Related Art

The Internet, which is a global network of dedicated lines having a high information transmission rate, is mainly used for electronic commerce and auction systems using servers storing diverse information.

When a user of a global site picks up news of an event of importance to himself, and provides this news to the server of the site over the Internet while assigning a specific code representing the nation and information associated with the event, it may be possible for global subscribers of the site to view the news over the Internet by entering a code corresponding to the specific code. Furthermore, where the server has global news provided by global users, it may be possible for each subscriber to view desired news by entering a code representing the nation associated with the news, and selecting a desired one of news topics displayed by the server in association with events generated in the associated nation. Under these conditions, subscribers can view the news of global events.

### SUMMARY OF THE INVENTION

Therefore, an object of the invention is to provide an Internet broadcasting apparatus and method in which a server stores news picked up by subscribers and transferred over the Internet, along with information about the news assigned with specific codes (including a nation code and a code representing the kind of news), after sorting the transferred news according to nations, and subsequently supplies, in response to a subject code entered by a client wanting to view news and corresponding to a particular news subject such as political news or sports news in a particular nation, associated news to a client's terminal.

In accordance with one aspect, the present invention provides an Internet broadcasting apparatus comprising: a plurality of terminals each having functions of transferring, over the Internet, news picked by a user of the terminal in a news transfer mode, along with a code for allowing the news to be sorted by nation or other subject, while inputting a code representing the nation and language of news to be displayed on the terminal, and transferring the inputted code over the Internet in a broadcast view mode; a server, to which each of the terminals has access via the Internet, the server outputting, based on the code transferred from the terminal, sorting control information for sorting the news transferred from the terminal in association with the nation of the news, and translation control information for designating a language, into which the news is to be translated; a memory unit for storing the news provided by the terminal at a memory location corresponding to an address determined based on the sorting control information from the server, and outputting news data stored therein in response to a request made by at least one of the terminals; an automatic translating system for automatically translating news data outputted from the memory unit into the language designated based on the translation control information from the server; and a mixer for mixing the translated news data outputted from the automatic translating system with the news data outputted from the memory unit, and transferring the mixed data via the Internet to the at least one terminal.

In accordance with another aspect, the present invention provides an Internet broadcasting method comprising the steps of: determining whether a mode selected by a terminal corresponds to a news transfer mode or a broadcast view mode; if the selected mode corresponds to the news transfer mode, storing news transferred via the Internet from the terminal, based on nation and news subject codes assigned by a user of the terminal; if the selected mode corresponds to the broadcast view mode, analyzing a view code entered by the user, reading out news data from a memory based on the analyzed view code, and buffering the read-out news data; translating the news data read out from the memory into a language determined based on the analyzed view code;

mixing the translated news data with the buffered news data, and transferring the mixed data to the terminal via the Internet.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating an initial picture displayed when a subscriber is connected via the Internet to the site of an Internet broadcasting apparatus according to the present invention;

FIG. 2 is a table of nation codes for Internet broadcast;

FIG. 3 is a block diagram illustrating the Internet broadcasting apparatus according to the present invention; and

FIG. 4 is a flow chart illustrating the operation of the Internet broadcasting apparatus shown in FIG. 3.

### DESCRIPTION OF THE PREFERRED EMBODIMENTS

The present invention will be described in detail with reference to the annexed drawings.

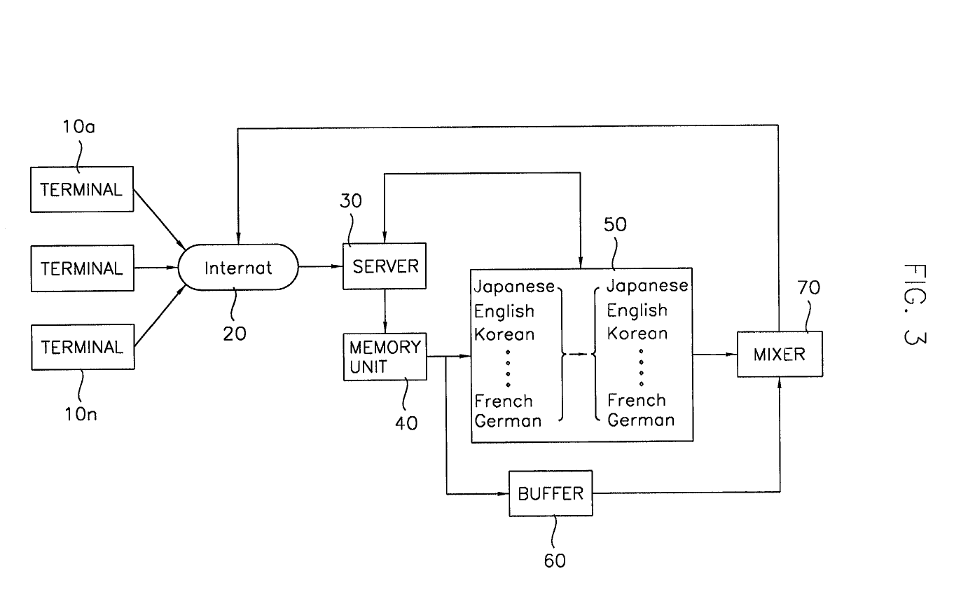

FIG. 3 is a block diagram illustrating an Internet broadcasting apparatus according to the present invention. As shown in FIG. 3, the Internet broadcasting apparatus includes a plurality of terminals 10 each having functions of transferring, over the Internet, news picked by a user of the terminal 10 in a news transfer mode, along with a code for allowing the news to be sorted in terms of nation or other subject, while inputting a code representing the nation and language of news to be displayed on the terminal 10, and transferring the inputted code over the Internet in a broadcast view mode. The Internet broadcasting apparatus also includes a server 30, to which each terminal 10 has access via the Internet. The server 30 outputs, based on the code transferred from each terminal 10, sorting control information for sorting the news transferred from the terminal 10 in association with the nation of the news, and translation control information for designating a language, into which the news is to be translated.

A memory unit 40 is also included in the Internet broadcasting apparatus. The memory unit 40 stores the news provided by the terminal 10 at a memory location corresponding to an address determined based on the sorting control information from the server 30. The Internet broadcasting apparatus further includes an automatic translating system 50 for automatically translating the news outputted from the memory unit 40 into the language designated based on the translation control information from the server 30.

Referring to 3, a buffer 60 is also illustrated which buffers the data outputted from the memory unit 40, and sends the buffered data to a mixer 70, which also receives the translated news data outputted from the translating system 50.

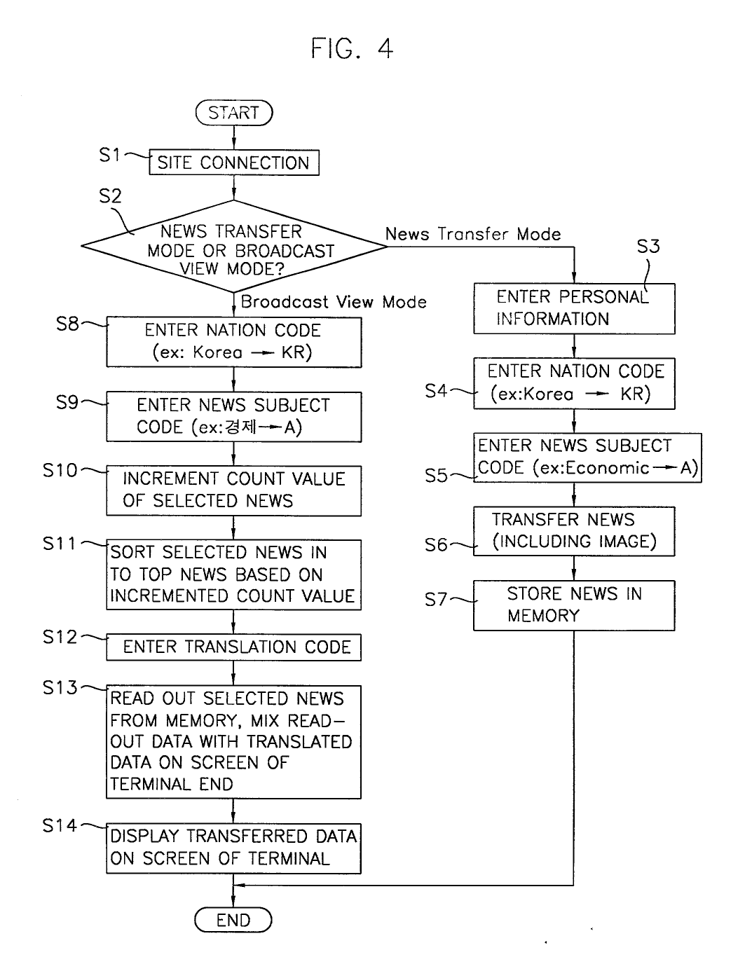

The operation of the Internet broadcasting apparatus having the above described configuration will now be described in detail with reference to a flow chart shown in FIG. 4.

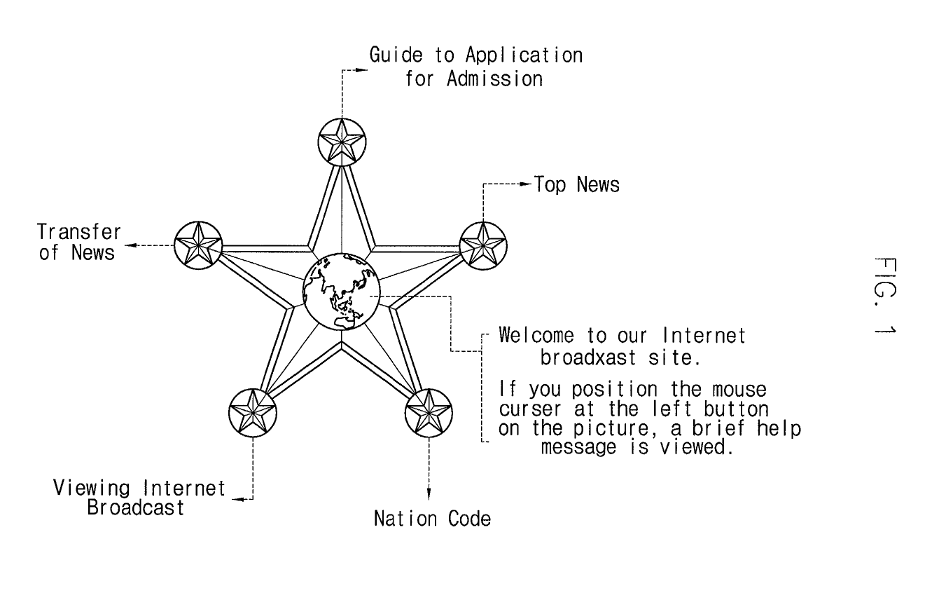

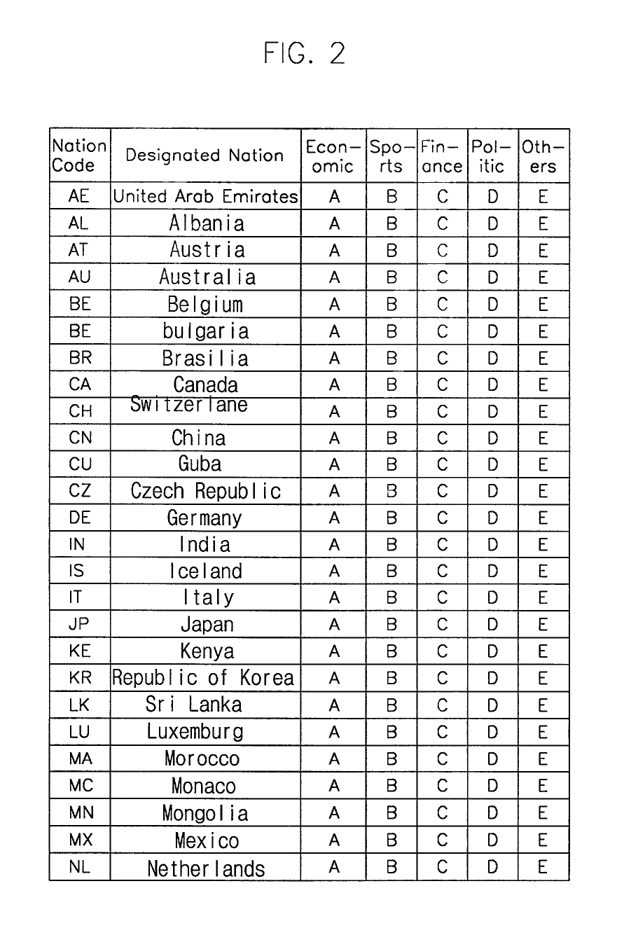

When a subscriber is connected via the Internet to the site of the Internet broadcasting apparatus, that is, the server 30, using his terminal 10 at step S1 of FIG. 4, an initial picture as shown in FIG. 1 is displayed on the terminal 10. When the subscriber clicks a desired mode on the displayed picture, it is determined at step S2 whether the clicked mode corresponds to a news transfer mode or a broadcast view mode. Where the mode clicked by the subscriber corresponds to the news transfer mode, the procedure proceeds to step S3. At step S3, the subscriber is requested to provide his personal information. Thereafter, steps S4 and S5 are executed. At step S4 and S5, the subscriber is requested to enter codes respectively representing the nation and subject of news to be transferred, while referring to a code table as shown in FIG. 2. Following steps S4 and S5, the subscriber transfers the news at step S6. The server 30 subsequently discriminates the codes included in a header of the transferred news, and assigns a desired address to the transferred news, based on the codes, thereby allowing the news to be stored in the memory unit 40 at a memory location corresponding to the assigned address, at step S7.

On the other hand, where it is determined at step S2 that the mode clicked by the subscriber corresponds to the news view mode, the procedure proceeds to step S8. At step S8, the server 30 requests the subscriber to enter a code corresponding to a desired nation (for example, KR: Korea or IN: India). After identifying the entered code, the server 30 requests the subscriber to enter a code corresponding to a desired news subject (for example, A: Economic, B: Sports, or D: Politics) at step S9.

After the selection of a desired nation and a desired news subject, the server 30 increments, by one, a count value corresponding to the number of clicks made to view the news associated with the selected nation and news subject, at step S11, in order to sort the news into a top news group when the incremented click number of the news corresponds to a reference value for the top news group. In accordance with this function, the viewer can directly view top news by simply clicking a “Top News” item on the picture. Following step S11, the server 30 requests the subscriber to enter a translation code designating the language of the news selected to be displayed, at step S12.

In response to the translation code entered at step S12, the procedure proceeds to step S13. At step 13, data corresponding to the selected news is read out from the memory 40, and then sent to the automatic translating system 50. Based on the translation code, the automatic translating system 50 translates the news data into the language designated by the subscriber. The mixer 70 mixes the translated data, with the new data buffed by the buffer 60. The resultant data is supplied to the terminal 10 via the Internet 20. Accordingly, the supplied data is displayed on the screen of the terminal 10 in the form of a PIP (Picture In Picture) at step S14.

As apparent from the above description, the present invention provides an Internet broadcasting apparatus and method in which a server stores the news of events or sports picked up by subscribers and transferred over the Internet, in order to allow global clients to view the news. In accordance with the present invention, there is an effect of allowing global clients to rapidly recognize, via the Internet, important events around the world.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An Internet broadcasting apparatus comprising:
a plurality of terminals each having functions of transferring, over the Internet, news picked by a user of the terminal in a news transfer mode, along with a code for allowing the news to be sorted by nation or other subject, while inputting a code representing the nation and language of news to be displayed on the terminal, and transferring the inputted code over the Internet in a broadcast view mode;
a server, to which each of the terminals has access via the Internet, the server outputting, based on the code transferred from the terminal, sorting control information for sorting the news transferred from the terminal in association with the nation of the news, and translation control information for designating a language, into which the news is to be translated;
a memory unit for storing the news provided by the terminal at a memory location corresponding to an address determined based on the sorting control information from the server, and outputting news data stored therein in response to a request made by at least one of the terminals;
an automatic translating system for automatically translating news data outputted from the memory unit into the language designated based on the translation control information from the server; and
a mixer for mixing the translated news data outputted from the automatic translating system with the news data outputted from the memory unit, and transferring the mixed data via the Internet to the at least one terminal.

2. An Internet broadcasting apparatus according to claim 1, further comprising:
a buffer for buffering the news data outputted from the memory unit for a predetermined time, thereby matching the buffered news data with the news data outputted from the automatic translating system.

3. An Internet broadcasting method comprising the steps of:
determining whether a mode selected by a terminal corresponds to a news transfer mode or a broadcast view mode;
if the selected mode corresponds to the news transfer mode, storing news transferred via the Internet from the terminal, based on nation and news subject codes assigned by a user of the terminal;
if the selected mode corresponds to the broadcast view mode, analyzing a view code entered by the user, reading out news data from a memory based on the analyzed view code, and buffering the read-out news data;
translating the news data read out from the memory into a language determined based on the analyzed view code;
mixing the translated news data with the buffered news data, and transferring the mixed data to the terminal via the Internet.

4. The Internet broadcasting method according to claim 3, further comprising the step of:
if the selected mode corresponds to the broadcast view mode, determining, based on the analyzed code, whether or not news to be viewed by the user should be sorted into top news to be displayed on an initial picture displayed on a screen of the terminal.

5. The Internet broadcasting method according to claim 4, further comprising the step of:
transferring the top news to the terminal when the user selects the top news.
